(19) United States
(12) Patent Application Publication
(10) Pub. No.: US 2006/0183082 A1
(43) Pub. Date: Aug. 17, 2006

(54) METHOD AND COMPUTER SYSTEM FOR CREATING A DENTAL RESTORATION MODEL

(75) Inventors: Henley S. Quadling, Dallas, TX (US); Mark S. Quadling, Plano, TX (US)

Correspondence Address: LAW OFFICE OF DAVID H. JUDSON, 15950 DALLAS PARKWAY, SUITE 225, DALLAS, TX, 75248, US

(73) Assignee: D4D TECHNOLOGIES, LP, Richardson, TX (US)

(21) Appl. No.: 10/906,390

(22) Filed: Feb. 17, 2005

(51) Int. Cl. A61C 5/10

(52) U.S. Cl. 433/223; 433/218; 433/215; 433/202.1

(57) ABSTRACT

A method for generating a 3D model for a restoration is operative in a computer having a display. The method begins by obtaining a 3D model of the preparation. The preparation model may be obtained by an operator using a 3D digitizer. A “margin” curve on the preparation model is then determined. The method then continues by selecting a given 3D restoration cap model from a set of such models, where the set includes cap models that vary by one or more characteristics such as type, age, sex and ethnicity. The restoration cap model has a cap edge curve. According to the invention, the method then continues by fitting the restoration cap model over the preparation model (on the computer display) so that a minimum distance between the restoration cap and the restoration model is greater than a given minimum material thickness. The restoration cap model is then reshaped or otherwise scaled as necessary so that the restoration cap edge curve is related to the margin curve in a predetermined manner. In particular, preferably the cap edge curve is related to the margin curve by an angle from vertical that is equal or substantially equal to a given emergence angle at each point along the curve. To complete the model, a side surface is then created, preferably by lofting a surface from the margin curve to the cap edge curve.

### BACKGROUND OF THE INVENTION

The present invention relates to computer-assisted techniques for creating dental restoration models.

The art of fabricating custom-fit prosthetics in the dental field is well-known. Prosthetics are replacements for tooth or bone structure. They include restorations, replacements, inlays, onlays, veneers, full and partial crowns, bridges, implants, posts, and the like. Typically, a dentist prepares a tooth for a restoration by removing existing anatomy, which is then lost. The resultant prepared area (a “preparation”) is then digitized (or, in the alternative, a dental impression is taken) for the purpose of constructing a restoration. The restoration itself may be constructed through a variety of techniques including manually constructing the restoration, using automated techniques based on computer algorithms, or a combination of manual and automated techniques.

Computer-assisted techniques have been developed to generate three-dimensional (“3D”) visual images of physical objects, such as a dental preparation. In general, the 3D image may be generated by a computer that processes data representing the surfaces and contours of a physical object. The computer displays the 3D image on a screen or a computer monitor. The data may be generated by optically scanning the physical object and detecting or capturing the light reflected off of the object. Based on processing techniques, the shape, surfaces and/or contours of the object may be modeled by the computer. Optical scanning may be accomplished using a laser based system, such as the system described in “Laser Digitizer System for dental applications,” published Patent Application No. 20040254476, which is owned by D4D Technologies, LP. This application describes a laser digitizer having a light source, a scanner, a flat-field lens, an image capture instrument, and a processor configured to carry out instructions based on code, and to process digital data. The digitizer is used to scan a prepared area and to obtain a three dimensional (3D) data set representing the preparation as well as one or more teeth adjacent the preparation.

While computer-assisted techniques for creating a dental restoration model for a scanned preparation are known, these techniques do not always provide acceptable results. The present invention addresses this problem.

### BRIEF SUMMARY OF THE INVENTION

A method for generating a 3D model for a restoration is operative in a computer having a display. The method begins by obtaining a 3D model of the preparation. The preparation model may be obtained by an operator using a 3D digitizer if the model is not otherwise already available (or stored in) to the computer. A given curve on the preparation model is then determined, e.g., by the operator or the system. This curve is located at the margin where the final restoration is expected to join the preparation, and thus it is referred to herein as a “margin” curve. The method then continues by selecting a given 3D restoration cap model from a set of such models, where the set includes cap models that vary by one or more characteristics such as type, age, sex and ethnicity. The selection may be made by the operator, by the system, or in any other manner. The restoration cap model has an outer edge, which is referred to herein as a “cap edge.” The cap edge defines a cap edge curve that is then used in the modeling technique. In particular, in one embodiment, the method continues by fitting the restoration cap model over the preparation model (on the computer display) so that a minimum distance between the restoration cap and the restoration model is greater than a given minimum material thickness. The restoration cap model is then reshaped or otherwise scaled as necessary so that the restoration cap edge curve is related to the margin curve in a predetermined manner. In particular, preferably the cap edge curve is related to the margin curve by an angle from vertical that is equal or substantially equal to a given “emergence” angle at each point along the curve. To complete the model, a side surface is then created, preferably by lofting a surface from the margin curve to the cap edge curve.

The lofting process creates a well-defined tooth model. A more specific technique to generate the side surface is implemented, preferably by computer-executed program instructions, once the restoration cap has been positioned and shaped as required. In particular, preferably the side surface is formed by evaluating radial slices from the center of the restoration cap through the cap edge curve and the preparation's margin curve. Wherever the radial slice plane intersects the cap edge curve and the margin curve, a smooth curve is formed to join those two points. The curve may be formed using conventional means to join these points while maintaining a continuous first or second derivative at the cap edge. The set of smooth curves that are formed in the manner comprise the side surface of the tooth model. Each smooth curve may be further constrained to maintain a slope at the margin equal to the given emergence angle for that radial.

During the scaling operation, the restoration cap is positioned, shaped or scaled as required to enable the cap to fit between the existing teeth, as represented in the preparation. Such operations may be performed so that features in the restoration cap are aligned or otherwise line-up with features observed in the neighboring dentition, preferably as captured in the 3D scan of the preparation. For example, cusps of the cap may be lined up with cusps of the neighboring teeth. The central groove feature of the cap may be lined up with the equivalent feature in the tooth cap, and so forth.

Other features and advantages of the invention will be apparent to one with skill in the art upon examination of the following figures and detailed description. It is intended that all such additional features and advantages be included within this description, be within the scope of the invention, and be protected by the claims.

### BRIEF DESCRIPTION OF THE DRAWINGS

The invention may be better understood with reference to the following drawings and its accompanying description. Unless otherwise stated, the components in the figures are not necessarily to scale, emphasis instead being placed upon illustrating the principles of the invention. Moreover, in the figures, like referenced numerals designate corresponding parts throughout the different views.

FIG. 1 illustrates a computer system in which the inventive method may be implemented;

FIGS. 2A and 2B illustrate respective plan and elevation computer display views of a preparation as well as the adjacent teeth;

FIG. 3 illustrates a set of several possible restoration caps that may be used to facilitate completion of the preparation shown in FIG. 2;

FIG. 4 illustrates a selected one of the restoration caps of FIG. 3 and, in particular, a cap edge curve of that restoration cap;

FIG. 5 illustrates a radial slice through the preparation and the restoration cap after the preparation and cap have been aligned along a centroid axis;

FIG. 6 illustrates how a side surface is created according to the present invention by lofting the surface from the margin curve to the cap edge curve.

### DETAILED DESCRIPTION

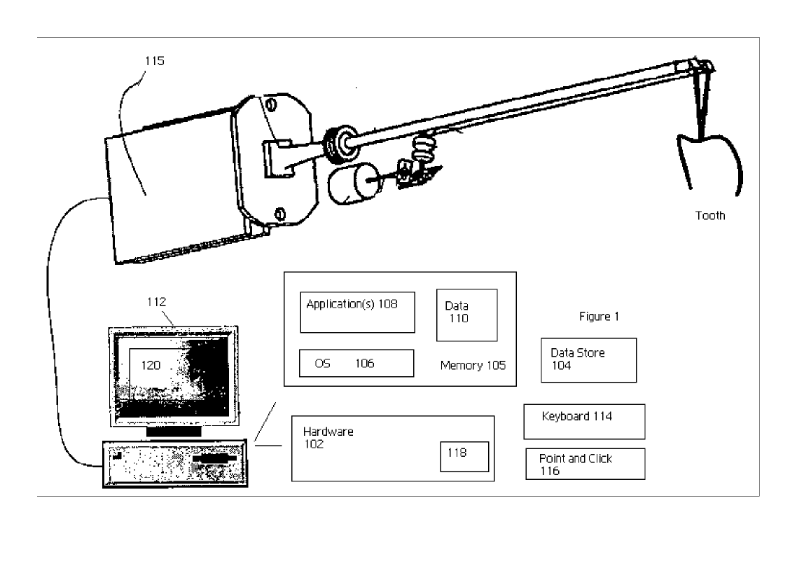

The present invention is a method implemented, preferably in a computer. For illustrated purposes, the computer is a single machine, but this is not a limitation. More generally, the method is implemented using a set of one or more computing-related entities (systems, machines, processes, programs, libraries, functions, or the like) that facilitate or provide the inventive functionality. As seen in FIG. 1, a representative machine is a computer running commodity hardware, an operating system, an application runtime environment, and a set of applications or processes (e.g., linkable libraries, native code, or the like, depending on platform), that provide the functionality of a given system or subsystem. The service may be implemented in a standalone machine, or across a distributed set of machines. The computer connects to the publicly-routable Internet, a corporate intranet, a private network, or any combination thereof, depending on the desired implementation environment.

More specifically, the computer 100 comprises hardware 102, suitable storage 104 and memory 105 for storing an operating system 106, one or more software applications 108 and data 110, conventional input and output devices (a display 112, a keyboard 114, a point-and-click device 116, and the like), other devices 118 to provide network connectivity, and the like. A laser digitizer system 115 is used to obtain optical scans, e.g., from preexisting anatomy. A representative digitizer system is described in commonly-owned, co-pending published application No. 20040254476, the disclosure of which is incorporated herein by reference. Using a conventional graphical user interface 120, an operator can view and manipulate models as they are rendered on the display 112.

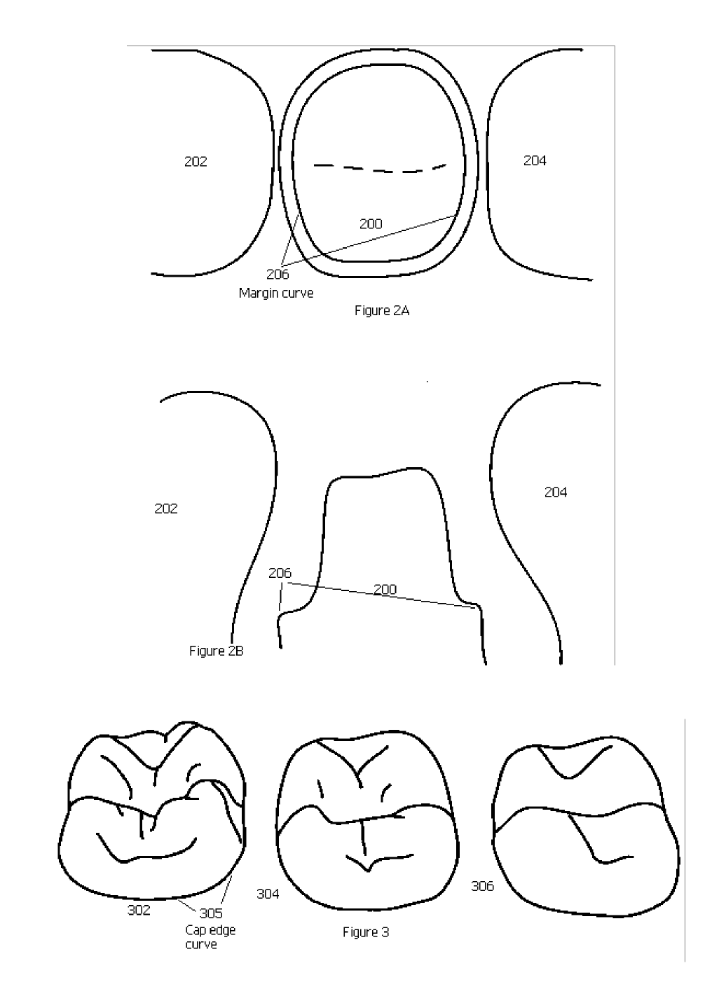

FIG. 2A is a plan view of scanned preparation 200 and adjacent teeth 202 and 204. FIG. 2B is an elevation. As is well known, the preparation 200 is created by removing existing anatomy. The particular geometry illustrated in merely representative. The present invention enables an operator (e.g., a dentist, a laboratory technician, or any other third party) to use the computer to create a dental restoration model for the scanned preparation. In this embodiment, a 3D digitizer system, such as the system 115 of FIG. 1, is used to provide an intra-oral scan of the prepared area to obtain a 3D data set representing the preparation as well as the patient's adjacent teeth. This is not a limitation of the inventive method, however, as the 3D data set may already exist or be otherwise available to the model generation routines.

As illustrated in FIGS. 2A and 2B, the preparation 200 includes a given margin, which represents the expected interface between the final restoration and the edge of the preparation. As illustrated in FIG. 2A, the margin extends around the preparation along a so-called “margin curve” 206. The margin is a physical constraint or characteristic of the actual preparation, and the associated margin curve may be generated manually (e.g., using a point-and-click input device 116) or automatically, by one or more routines executing on the computer. In a representative implementation, the operator traces the curve at the appropriate position and the resulting data set representing the margin curve is captured by the system.

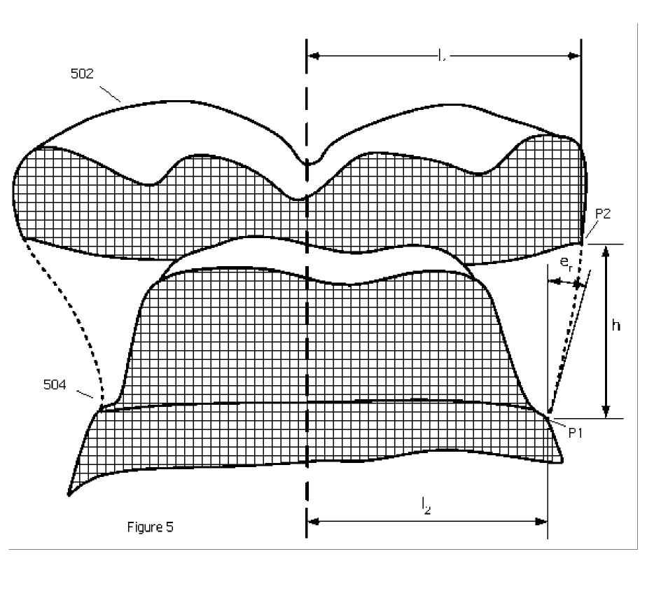

Another 3D surface, called a restoration cap model, is then selected. This selection may be made by the operator, by the system using automated techniques, by a combination of such techniques, or in any other convenient manner. As illustrated in FIG. 3, preferably a set or library of restoration cap models is stored or otherwise available to the operator or the system. FIG. 3 illustrates a set of three (3) cap models 302, 304 and 306, although, of course, the cap model library may have any number of models. Each cap model has an outer edge, which defines a curve that is referred to herein as the “cap edge” curve 305, as it is the curve that defines the edge. In this example, FIG. 3 illustrates three possible restoration caps for the tooth preparation model based on typical dental anatomy for a given population for three different age groups. Cap model 302 is for youthful anatomy where there has been little or no wear of dental features. Cap model 304 is for middle aged anatomy where there has been some wear of dental features over time. Cap model 306 is for aged anatomy where much of the detail has been worn down over the years. The set of models in FIG. 3 comprises models indexed by age, but this is not a limitation of the invention either. The library may comprise models that are characterized by one or more factors such as type, age, sex, ethnicity, or combinations thereof. According to the invention, a restoration cap model is selected from a set of models based on at least one such factor. Of course, it is desirable to choose a restoration cap that most closely resembles the patent's other dentition, especially the neighbor teeth. If desired, or if a library is not available, this particular step may be omitted.

As illustrated in FIG. 3, each of the restoration caps in the given set are shown as having a substantially flat base, however, this is not a limitation. In general, a restoration cap may have a boundary base curve 305 that is not necessarily flat. FIG. 4 illustrates one of the restoration caps in more detail. The shaded portion of the figure represents the interior of the cap. As illustrated in FIG. 4, the curve forming the base edge of the cap 400 is the cap edge curve 402. As can be seen, the selected cap 400 is positioned to that the cap edge curve 402 as well as the interior 404 of the cap are visible.

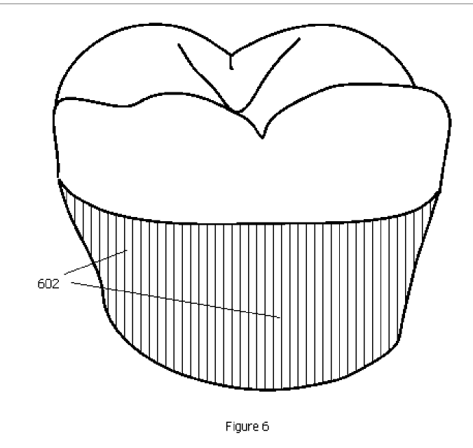

In most cases, the restoration cap illustrated in FIG. 4 is not the correct size or shape to match the preparation and the original tooth. Thus, according to the inventive method, the restoration cap model must be positioned, resized and/or reshaped relative to the preparation model. This step preferably is implemented by having the operator use one or more input devices, such as a point-and-click device, as the various models are displayed or otherwise rendered on the computer display. The first step in the process is to correctly position, resize and reshape the restoration cap. To this end, as illustrated in FIG. 5, preferably the margin curve is used to identify the portion of the preparation that will be beneath the cap. The cap model 502 is then moved (e.g., by dragging) so that it is placed approximately over a centroid of the margin curve. The cap is also positioned vertically so that a given (preferably user-provided) minimum distance is located between every point on the cap and the preparation surface 504 beneath it. This substep is performed to ensure minimum material thickness of the final restoration. If necessary, the cap is also reshaped to more closely follow the margin curve. In one embodiment, this is done by scaling the tooth cap along a radial direction from the center outwards, for each radial r. FIG. 5 represents one such radial. Referring to FIG. 5, if the length of tooth cap radial is denoted by l₁, the length of the equivalent radial for the margin curve is denoted by l₂, and the height difference is h, then l₁=l₂+h tan eᵣ, where eᵣ is the emergence angle at that point on the margin. The emergence angle eᵣ may be specified for each such radial. These values are illustrated in FIG. 5.

The cap may be further positioned, shaped or scaled as required in order for the cap to fit between the existing teeth. Such operations may be performed so that features in the cap line up with features observed in the neighboring dentition, as captured in the 3D scan of the preparation. For example, cusps of the cap may be lined up with cusps of the neighbors. The central groove feature of the cap may be lined up with the equivalent feature in the tooth cap. The cap may be adjusted so that the cap cusp height follows the curve of Spee with respect to the cusp height of the neighbors.

Once the cap has been positioned and shaped as required, the side surface is formed by looking at radial slices from the center of the cap through the cap edge curve and the margin curve. Wherever the radial slice plane intersects the cap edge curve and the margin curve, a smooth curve is formed that joins those two points, which are designated P1 and P2 in FIG. 5. The curve may be described as a polynomial (or by any other continuous function that may be approximated by a polynomial) that has a set of boundary conditions: namely, preferably the curve is continuous at the endpoints and the slopes, where the slope at P1 is given by the emergence angle for the radial, and further the curve has at most one local maximum or minimum (excluding the endpoints). The slope of P2 is obtained from the cap. In one embodiment, the curve is formed to join points P1 and P2 while maintaining a continuous first and/or continuous second derivative at the cap edge. The curve may be further constrained to maintain a slope at the margin equal to the emergence angle eᵣ for that radial. Of course, each radial slice plane in the 3D model may have a different curve. The set of curves that are formed in this manner comprise a side surface 602 for the model 600, as illustrated in FIG. 6.

As used herein, the side surface is created by a computer-implemented surface “lofting,” which is a known surfacing process that creates a surface using a series of curves as profiles between a starting curve and an ending curve. Further details of surface lofting are described, for example, in “The NURBS book” by Les A. Piegl and Wayne Tiller, 2d Edition.

Thus, according to the invention, a restoration cap model is positioned over the preparation model so that a minimum distance between the restoration cap model and the preparation model is greater than a given specified material thickness. The restoration cap model is then shaped to conform to the margin curve of the preparation model. Thereafter, a side surface is lofted from the margin curve to the edge curve to generate the outer surface of the three dimensional model for the restoration. The interior portion of the restoration model is of course obtained from the 3D image of the preparation itself (namely, that part of the digitized preparation contained within the margin curve). This is the part of the restoration model that is not designed; rather, it is obtained from the model itself as it is the interface between the restoration and the preparation.

In an alternative embodiment, a restoration cap model is first selected from a set of restoration cap models. The restoration cap model is then positioned, resized and reshaped as necessary to conform to the preparation model. To complete the model, the side surface is lofted, along each radial, from the margin curve of the preparation to the edge curve of the restoration cap. The resulting 3D model is then used to create the dental restoration using conventional means.

While certain aspects or features of the present invention have been described in the context of a computer-based method or process, this is not a limitation of the invention. Moreover, such computer-based methods may be implemented in an apparatus or system for performing the described operations, or as an adjunct to other dental restoration equipment, devices or systems. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. Further, while given components of the system have been described separately, one of ordinary skill will appreciate that some of the functions may be combined or shared in given systems, machines, devices, processes, instructions, program sequences, code portions, and the like.

Having now described our invention, what we claim is as follows:

What is claimed is:

1. A method, using a computer, for generating a three dimensional (3D) model for a restoration, wherein a preparation model for the restoration includes a margin curve, comprising the unordered steps:
positioning a restoration cap model over the preparation model so that a minimum distance between the restoration cap model and the preparation model is greater than a given specified material thickness, the restoration cap model having an edge curve;
shaping the restoration cap model to conform to the margin curve of the preparation model; and
lofting a side surface from the margin curve to the edge curve to generate the three dimensional model for the restoration.

2. The method as described in claim 1 further including step of selecting the restoration cap model from a set of restoration cap models.

3. The method as described in claim 2 wherein the restoration cap model is selected from the set based on at least one factor selected from the set: type, age, sex or ethnicity.

4. The method as described in claim 1 wherein the restoration cap model is positioned over a centroid of the margin curve.

5. The method as described in claim 1 wherein the shaping step scales the restoration cap model along a radial direction from a center of the model outwards, for each radial r.

6. The method as described in claim 5, wherein, if a cap model radial has length l₁, a corresponding preparation model radial has length l₂, and the cap model and preparation model radials are positioned at a height difference h, then the cap model radial is scaled l₁=l₂+h tan eᵣ, where eᵣ is an emergence angle.

7. The method as described in claim 1 wherein the restoration cap model is obtained by scanning a physical model.

8. The method as described in claim 1 wherein the restoration cap model is obtained by scanning anatomy.

9. The method as described in claim 1 wherein, as a result of the scaling step, at least one cusp of the restoration cap model is aligned with at least one cusp of a neighboring tooth.

10. The method as described in claim 1 wherein, as a result of the scaling step, the cusp of the restoration cap model is aligned along a curve of Spee.

11. The method as described in claim 1 wherein, as a result of the scaling step, a restoration cap model central groove is aligned with a central groove of a neighboring teeth.

12. A method, using a computer, for generating a three dimensional (3D) model for a restoration, wherein a preparation model for the restoration includes a margin curve, comprising the unordered steps:
selecting a restoration cap model from a set of restoration cap models, the restoration cap model having an edge curve;
positioning, resizing and reshaping the restoration cap model as necessary with respect to the preparation model; and
lofting a side surface from the margin curve to the edge curve to generate the three dimensional model for the restoration.

13. The method as described in claim 12 wherein the restoration cap model is selected from the set based on at least one factor selected from the set: type, age, sex or ethnicity.

14. A method, using a computer, for generating a three dimensional (3D) model for a restoration, wherein a preparation model for the restoration includes a margin curve, comprising the unordered steps:
positioning a restoration cap model over the preparation model, the restoration cap model having an edge curve;
positioning, resizing and reshaping the restoration cap model as necessary with respect to the preparation model; and
with respect to a given radial slice plane in the 3D model, forming a smooth curve that intersects the edge curve and margin curve, the smooth curve having a polynomial form.
